(19) United States
(12) Patent Application Publication
(10) Pub. No.: US 2007/0165901 A1
(43) Pub. Date: Jul. 19, 2007

(54) Speaker bracket and speaker

(75) Inventors: Shinichi Hayasaka, Yamagata (JP); Koji Takayama, Yamagata (JP); Hiroyuki Kobayashi, Yamagata (JP)

Correspondence Address: SUGHRUE-265550, 2100 PENNSYLVANIA AVE. NW, WASHINGTON, DC, 20037-3213, US

(73) Assignees: PIONEER CORPORATION, Tokyo (JP); TOHOKU PIONEER CORPORATION, Tendo-shi (JP)

(21) Appl. No.: 11/646,367

(22) Filed: Dec. 28, 2006

(30) Foreign Application Priority Data
Dec. 28, 2005 (JP) P2005-378397

(51) Int. Cl. H04R 1/02

(52) U.S. Cl. 381/386

(57) ABSTRACT

A speaker bracket disposed between a front end circumferential wall of a speaker frame and a speaker mounting portion of a cabinet as an adjuster, the speaker bracket includes a body formed into an approximate ring shape. The body includes a first surface and a second surface. The first surface has a frame adjusting portion to be secured to the front end circumferential wall. The second surface has a cabinet adjusting portion fixed to the speaker mounting portion. The frame adjusting portion is attachable to the front end circumferential wall from both a front side and a rear side of the speaker frame.

### CROSS-REFERENCE TO RELATED APPLICATIONS

This application is based upon and claims the benefit of priority from Japanese Patent Application NO. P2005-378397, filed Dec. 28, 2005, the entire contents of which are incorporated herein by reference.

### BACKGROUND OF THE INVENTION

1. Field of the Invention

The present invention relates to a speaker bracket and a speaker.

2. Background Art

A speaker provides predetermined acoustic reproduction, generally by fixing a speaker unit to a speaker mounting portion, such as a cabinet, that is formed on a baffle board.

A common speaker unit is designed so that a diaphragm and a magnetic circuit, for driving the diaphragm, are assembled in a speaker frame and cabinet mounting portions are prepared for the front side wall of the speaker frame, that are to be secured to a speaker mounting portion by screws.

But when, for example, speaker mounting portions are formed on the doors of vehicles, because of positional relationships, relative to other components with which the doors may be equipped, and spatial limitations, the sizes of these portions frequently differ slightly from the cabinet mounting portions provided for speaker units.

However, to resolve such mounting size mismatches between the front side wall cabinet mounting portions and the speaker mounting portions, a variety of types of speaker frames are prepared for which the sizes and the locations of the cabinet mounting portions differ, productivity is adversely affected and manufacturing costs rise sharply.

Therefore, various speaker designs have been proposed so that, to attach a speaker unit to a speaker mounting portion, a speaker bracket is positioned between a front end circumferential wall of the unit and the speaker mounting portion and is used to adjust a mounting size between the front end circumferential wall and the speaker mounting portion (see, for example, JP-A-2003-63316 and JP-A-10-250492).

A speaker unit is packaged for shipment using packaging components, formed, for example, of cardboard, corrugated cardboard or Styrofoam, to immobilize and cushion the unit and prevent impact and other damage while the unit is being transported and handled prior to delivery.

Conventional packaging structures are shown in FIGS. 1 and 2.

The packaging structure in FIG. 1 is an example wherein one speaker unit 1 is immobilized by employing two packaging components 3 and 4.

The packaging structure in FIG. 2 is an example wherein a bracket 2, used as a mounting size adjustment, is assembled with a speaker 1, and the speaker 1 and the bracket 2 are immobilized by employing two packaging components 5 and 6.

In FIGS. 1 and 2, for the speaker 1, cabinet mounting portions (screw fastening portions) 11a, which are to be fixed to a speaker mounting portion, such as a cabinet, are formed on a front end circumferential wall 11b of a speaker frame 11, and a diaphragm 13 and a magnetic circuit 14, for driving the diaphragm 13, are assembled with the speaker frame 11.

In either case, the diaphragm 13 is cone shaped, and to attach this diaphragm 13 to the speaker frame 11, the outer wall of a roll edge 15, which is integrally formed with the outer edge of the diaphragm 13, is secured to an edge fixing portion (not shown) internally provided along the front end circumferential wall 11b.

The bracket 2 is formed almost as a ring, and on one face, frame aligning portions 51 are formed that are to be fastened to the rear face of the front end circumferential wall 11b of the speaker frame 1 . Onthe other face of the bracket 2, cabinet aligning portions 52 are provided that are to be fixed to the speaker mounting portion, such as a cabinet, and are used as fittings for the mounting sizes of the front end circumferential wall 11b and the speaker mounting portion when the speaker 1 is attached to the speaker mounting portion.

In this case, the packing components 3 to 6 are made, for example, of Styrofoam, and the form of their shapes and sizes are such that they are consonant with the outer shape and size of the speaker unit 1.

For the packaging components 3 and 5, a step portion 3b, which contacts the rear end face of the front end circumferential wall 11b, and a step portion 5b, which contacts the rear end face of the bracket 2 assembled with the front end circumferential wall 11b, are respectively formed around recessed portions 3a and 5a, where the rear portion of the speaker 1 is fitted.

Since the front end circumferential wall 11b is gripped between the packaging component 4 or 6 and the step portion 3b or 5b of the packaging component 3 or 5, the speaker unit 1 is prevented from popping of the recessed portion 3a or 5a due to vibration or an impact that occurs in transit, prior to delivery.

However, according to the conventional packaging structure that prevents the speaker unit 1 from popping out of the packaging components 3 and 5, the packaging components 4 and 6 directly hold the front face of the front end circumferential wall 11b. Further, in order to avoid the interference of the internal walls of the packaging components 4 and 6 with the roll edge 15, the length w of a projected portion 4a or 6a, which extends over the front end circumferential wall 11b, is limited to only a small value.

As a result, only a small contact area is provided for the projected portion 4a or 6a that holds the speaker unit 1. Thus, should a box in which a heavy speaker unit 1 is packaged be dropped, shear stress, having a strength commensurate with the height from which dropped, will act on the unit area, and the projected portion 4a or 6a may be destroyed or deformed. Accordingly, the speaker unit 1 could be shifted and damaged.

In order to prevent the occurrence of such a problem, according to one corrective proposal, the entire front face of the speaker unit 1 is covered with a protective cover, as an additional packaging component, that increases the length w of the projected portion 4a or 6a. However, when this method is used, because the number of packaging components is increased, the packaging structure becomes more complicated, so that either the design of packaging becomes more difficult or manufacturing costs are increased.

### SUMMARY OF THE INVENTION

Problems to be resolved by one embodiment according to the invention are: a problem that has been encountered with the conventional art, i.e., a problem in that since an extended length cannot be provided for the projected portion of a packaging component that holds a speaker, the projected portion may tend to be destroyed or deformed if a package is dropped, and accordingly, since the projected portion may be destroyed or deformed, the speaker may be easily damaged; and a problem associated with reinforcing the packaging protection provided for a speaker, i.e., a problem in that since the number of packaging components would have to be increased, the packaging structure would become more complicated and either packaging design would be excessively difficult or manufacturing costs would be increased.

To solve these problems, according to a first aspect of the invention, there is provided a speaker bracket disposed between a front end circumferential wall of a speaker frame and a speaker mounting portion of a cabinet as an adjuster. The speaker bracket includes a body formed into an approximate ring shape. The body includes a first surface and a second surface. The first surface has a frame adjusting portion to be secured to the front end circumferential wall. The second surface has a cabinet adjusting portion fixed to the speaker mounting portion. The frame adjusting portion is attachable to the front end circumferential wall from both a front side and a rear side of the speaker frame.

According to a second aspect of the invention, there is provided a speaker mounted on a speaker mounting portion of a cabinet. The speaker includes a speaker unit and a speaker bracket. The speaker unit includes a speaker frame including a front end circumferential wall having a cabinet mounting portion formed on the front end circumferential wall, a diaphragm mounted on the speaker frame, and a magnetic circuit that drives the diaphragm, and that is mounted on the speaker frame. The speaker bracket is disposed between the front end circumferential wall and the speaker mounting portion as an adjuster. The speaker bracket includes a body formed into an approximate ring shape. The body includes a first surface and a second surface. The first surface has a frame adjusting portion to be secured to the front end circumferential wall. The second surface has a cabinet adjusting portion to be fixed to the speaker mounting portion. The frame adjusting portion is attachable to the front end circumferential wall from both a front side and a rear side of the speaker frame.

### BRIEF DESCRIPTION OF THE DRAWINGS

The present invention may be more readily described with reference to the accompanying drawings:

FIG. 1 is a vertical cross-sectional view of a packing structure for a conventional speaker;

FIG. 2 is a vertical cross-sectional view of a packing structure for a case wherein a speaker bracket is attached to the conventional speaker;

FIG. 3 is an exploded perspective view of a case wherein a speaker bracket and a speaker according to a first embodiment of the present invention are to be mounted on a speaker mounting portion;

FIG. 4 is a cross-sectional view of the state wherein the speaker in FIG. 3 is mounted on the speaker mounting portion;

FIG. 5 is a perspective view of the positional relationship of the speaker unit and the speaker bracket when the speaker in FIG. 3 is to be packed;

FIG. 6 is a vertical cross-sectional view of the packed state of the speaker in FIG. 3;

FIG. 7 is an exploded perspective view of a case wherein a speaker bracket and a speaker according to a second embodiment of the present invention are to be mounted on a speaker mounting portion;

FIG. 8 is a front view of the speaker bracket in FIG. 7;

FIG. 9 is a rear view of the speaker bracket in FIG. 7;

FIG. 10 is a cross-sectional view taken along A-A in FIG. 8;

FIG. 11 is a diagram showing the speaker bracket in FIG. 8, viewed from a direction indicated by an arrow B;

FIG. 12 is a cross-sectional view taken along C-C in FIG. 9; and

FIG. 13 is an enlarged diagram showing a portion D in FIG. 8;

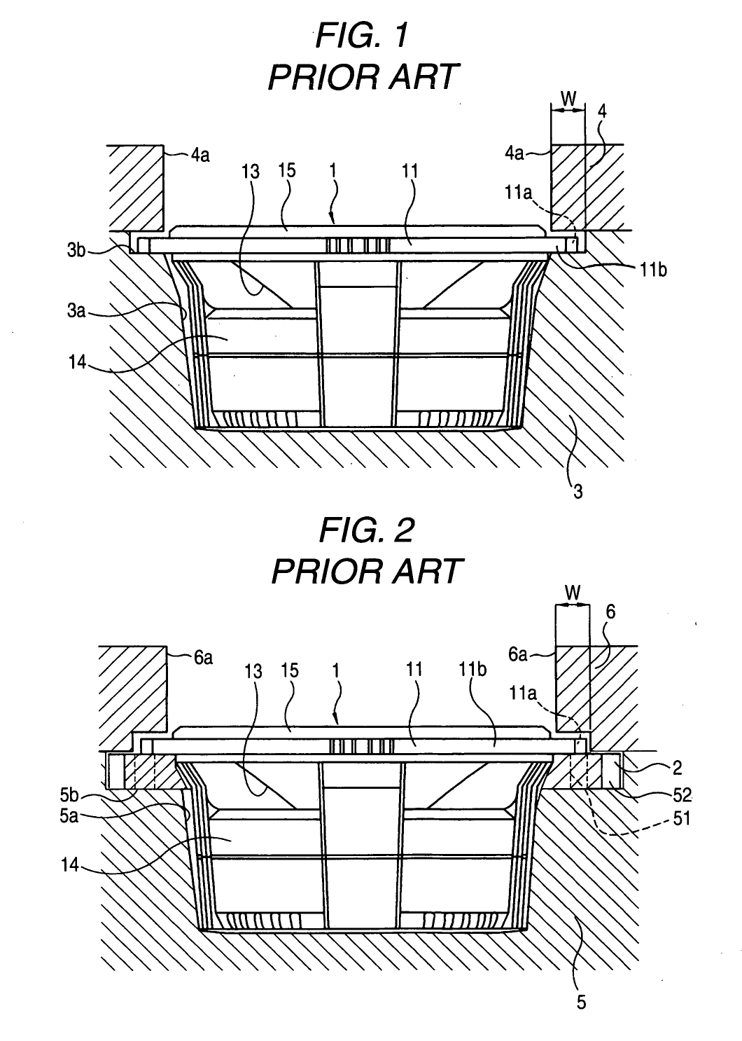

### DETAILED DESCRIPTION OF THE PREFERRED EMBODIMENTS

A speaker bracket and a speaker according to the present invention will be described.

The speaker of this invention includes a speaker unit and a speaker bracket. The speaker unit is obtained by assembling a diaphragm and a magnetic circuit for driving the diaphragm, with a speaker frame wherein cabinet mounting portions, which are to be fixed to a speaker mounting portion, such as a cabinet, are formed on a front end circumferential wall. The speaker bracket is positioned between the front end circumferential wall and the speaker mounting portion when the speaker unit is attached to the speaker mounting portion, and is used for matching the mounting size between the front end circumferential wall and the speaker mounting portion.

The speaker bracket is formed almost like a ring, and on one face, frame aligning portions are formed that are to be fastened to the front end circumferential wall of the speaker frame, while on the other face, cabinet aligning portions are formed that are to be fixed to the speaker mounting portion, such as a cabinet, that secures the front end circumferential wall.

For the speaker bracket, the frame aligning portions are formed so as to be attachable from the front end circumferential wall, from the front and the rear of the speaker frame.

According to the above arrangement, during the packaging process, the speaker bracket is attached, from the front of the speaker unit, to the front end circumferential wall of the speaker frame and to the speaker unit. As a result, the speaker bracket serves as a protective cover that encloses the front face of the speaker, while providing a protective gap in front of the diaphragm of the speaker unit.

Sequentially, when the speaker is packed in a state wherein the speaker bracket has been attached, from the front of the speaker unit, to the front end circumferential wall of the speaker frame, the projected portion of a packaging component, which prevents the speaker unit from popping out to the front, does not directly contact the front end circumferential wall of the speaker frame, and holds the other face of the speaker bracket that includes the cabinet aligning portions. Therefore, when the length of the projected portion is increased toward the center axis of the speaker, the projected portion does not adversely affect the roll edge that projects outward, from inside the front end circumferential wall, to a position forward of the speaker. Thus, a large contact area is provided for the projected portion that holds the speaker bracket.

Therefore, if a box in which a speaker unit is packaged is dropped, the shear force imposed on the projected portion of the packaging component by the speaker unit is received by and distributed across a large contact area, and the destruction or deformation of the projected portion can be prevented. Thus, the speaker can be immobilized and protected from damage.

Further, in this invention, the speaker bracket, which is originally located between a speaker and a speaker mounting portion to adjust a mounting size, is attached to the front end circumferential wall from the front of the speaker frame. Thus, the speaker bracket functions as a protective cover for the front cover of the speaker unit. Since the speaker bracket provides reinforced protection for the speaker unit, the need for an additional packaging component that would furnish such reinforcement is eliminated.

Therefore, the packaging structure is simplified and prevented from becoming complicated due to an increase in the packaging components, so that a box for packaging can be easily designed and manufacturing costs can be reduced.

### The First Preferred Embodiment

The embodiments of the present invention will be specifically explained.

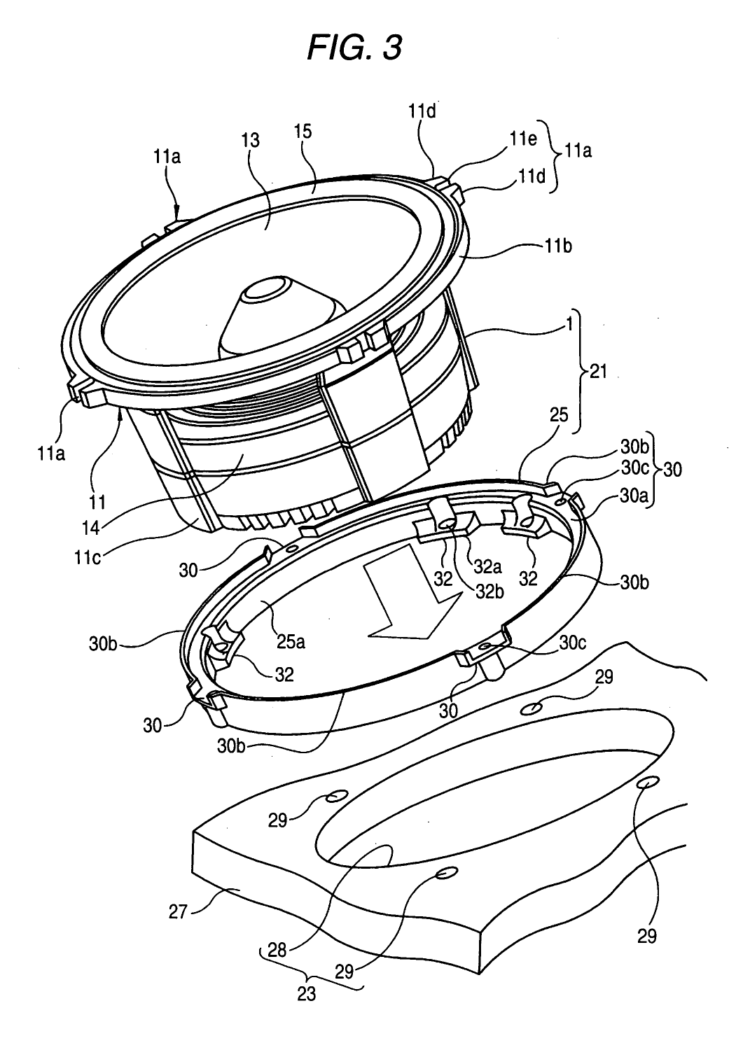

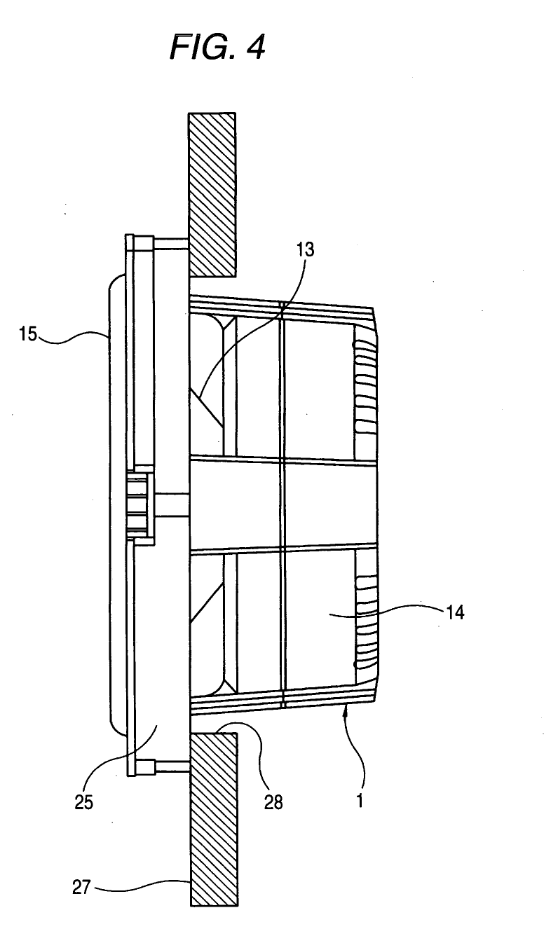

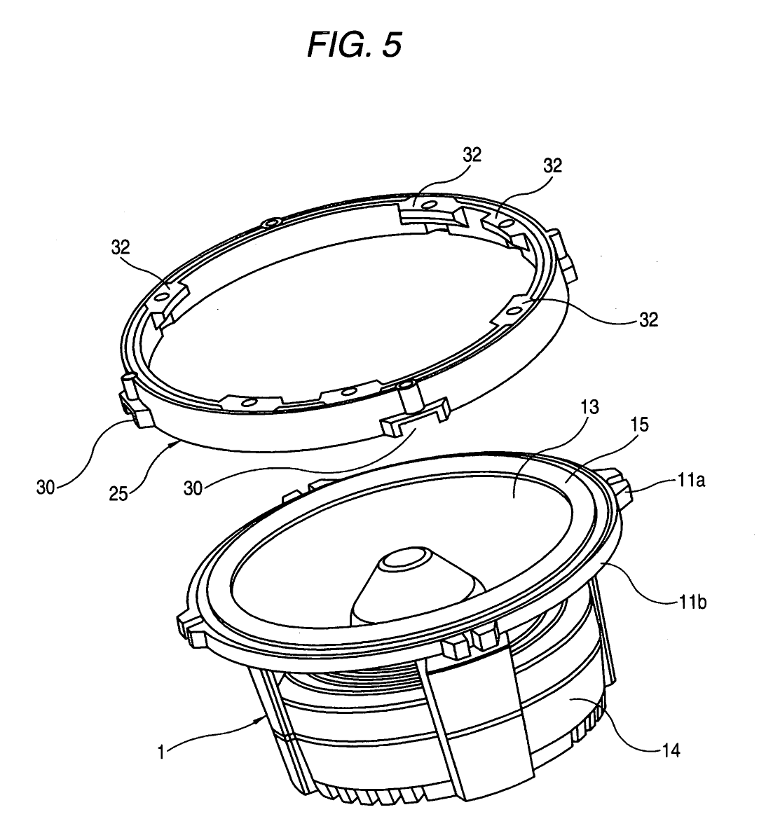

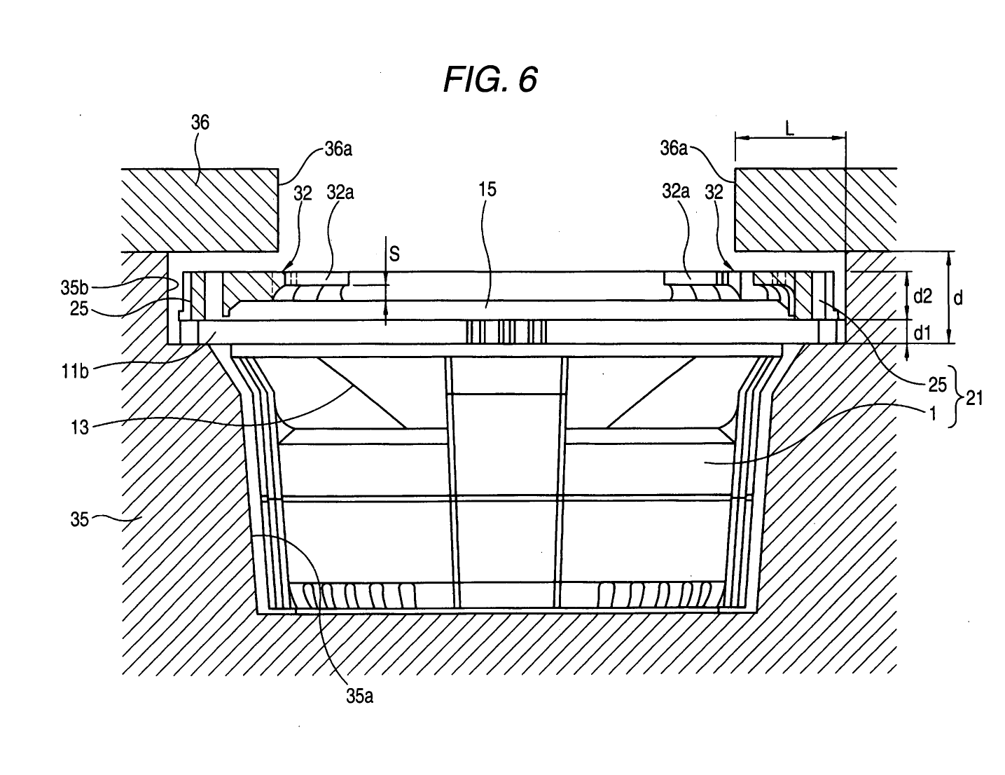

FIG. 3 is a vertical cross-sectional view of a speaker bracket and a speaker according to a first embodiment of the present invention. FIG. 4 is a cross-sectional view of the state wherein the speaker in FIG. 3 is attached to a speaker mounting portion. FIG. 5 is a perspective view of the positional relationship between a speaker unit and the speaker bracket when the speaker in FIG. 3 is to be packed. And FIG. 6 is a vertical cross-sectional view of the packed state of the speaker in FIG. 3.

A speaker 21 in this embodiment includes: a speaker unit 1, formed by assembling a diaphragm 13 and a magnetic circuit 14, which drives the diaphragm 13, in a speaker frame 11 wherein cabinet mounting portions 11a are formed on a front end circumferential wall 11b and are to be fixed to a speaker mounting portion 23, such as a cabinet; and a speaker bracket 25, which is to be positioned between the front end circumferential wall 11b and the speaker mounting portion 23 when the speaker unit 1 is attached to the speaker mounting unit 23, and serves as a fitting for the mounting size between the front end circumferential wall 11b and the speaker mounting portion 23.

For the speaker frame 11, the front end circumferential wall 11b, which is shaped almost like a ring, and a magnetic circuit supporting portion 11c, which extends to the rear of the front end circumferential wall 11b, are integrally formed while being cast. The inner front inner surface of the front end circumferential wall 11b serves as an edge supporting portion.

In this embodiment, the cabinet mounting portions 11a respectively provide screw insertion portions 11e using a pair of facing claws lid and 11d.

The diaphragm 13 is a cone shaped object to which the outer edge of a roll edge 15 is bonded. The outer wall of the roll edge 15 is further securely adhered to the edge supporting portion of the front end circumferential wall 11b.

The speaker mounting portion 23 is formed, for example, using a baffle board 27 for a cabinet, and includes a speaker fitting hole 28, into which the rear portion of the speaker unit 1 is to be inserted, and a plurality of screw fastening holes 29, which are formed along a pitch circle surrounding the speaker fitting hole 28.

In this embodiment, the inner diameter of the speaker fitting hole 28 is larger than the outer diameter of the magnetic circuit supporting portion 11c, and is slightly smaller than the standard diameter of a fitting hole for the speaker unit 1. Also, the diameter of the speaker fitting hole 28 is smaller than the diameter of the pitch circle along which are arranged the fastening holes 29, and the diameter of the pitch circle along which are arranged the screw insertion portions 11e of the front end circumferential wall 11b of the speaker frame 11.

That is, between the front end circumferential wall 11b of the speaker frame 11 and the speaker mounting portion 23 the mounting size does not match.

As for the speaker bracket 25, frame aligning portions 30, which are to be fastened to the front end circumferential wall 11b of the speaker frame 11, are provided on one face of a main body 25a shaped almost like a ring, and cabinet aligning portions 32, which are to be fixed to the speaker mounting portion 23 that secures the front end circumferential wall 11b, are provided on the other face of the main body 25a.

The frame aligning portions 30 respectively include: a ring-shaped horizontal contact face 30a, which is used in common and which the front face or the rear face of the front end circumferential wall 11b contacts; vertical contact walls 30b, which contact the outer face of the front end circumferential wall 11b and regulate movement along the horizontal contact face 30a; and fastening holes 30c, which are formed in the horizontal contact face 30a in consonance with the screw insertion portions 11e of the cabinet mounting portions 11a.

As for the cabinet aligning portions 32, in consonance with the fastening holes 29 of the speaker mounting portion 23, fastening holes 32b are formed in protrusions 32a that are formed on the internal walls on one side of the main body 25a.

The cabinet aligning portions 32 are located at a plurality of positions on the inner wall of the main body 25a, in consonance with the arrangement of the fastening holes 29 of the speaker mounting portion 23.

The obverse faces of the protrusions 32a on the speaker mounting portion 23 side are flattened, which permits them to be closely attached to the speaker mounting portion 23.

The same structure is employed for the front side and the side of the front end circumferential wall 11b of the speaker frame 11.

Therefore, as shown in FIGS. 4 to 6, from the front and from the rear of the speaker frame 11, the frame aligning portions 30 of the speaker bracket 25 can be fitted over the front end circumferential wall 11b of the speaker frame 11.

The size of the speaker bracket 25 in the axial direction is so designated that, as shown in FIG. 6, when the speaker bracket 25 is assembled with the front end circumferential wall 11b of the speaker frame 11 from the front of the speaker frame 11, a protective gap S is provided between the protrusions 32a of the cabinet aligning portions 32 and the distal end of the roll edge 15 that is extended to the front of the speaker unit 1, and thus, the protrusions 32a are extended forward of the roll edge 15 and the diaphragm 13.

In this case, the protective gap S is set to a value such that when the roll edge 15 or the diaphragm 13 is axially displaced, due, for example, to vibrations during delivery or transportation, the displacement will not adversely affect the speaker bracket 25.

When the speaker unit 1 is to be attached to the speaker mounting portion 23 of the baffle board 27, as shown in FIG. 4, the speaker bracket 25 described above is employed by being assembled within the front end circumferential wall 11b of the speaker frame 11, from the rear of the speaker frame 11.

For the assembly of the baffle board 27, it is appropriate for the speaker bracket 25 to be attached to the baffle board 27, and then, for the speaker unit 1 to be fitted to the speaker bracket 25.

For packaging the speaker unit 1, as shown in FIG. 5, the speaker bracket 25 is fitted on the front end circumferential wall 11b, from the front of the speaker unit 1, so that the frame aligning portions 30 of the speaker bracket 25 are located opposite the cabinet mounting portions 11a of the front end circumferential wall 11b.

When the cabinet mounting portions 11a and the frame aligning portions 30a refastened together by screws, the speaker bracket 25 can be securely fixed to the front race of the speaker unit 1.

When the packaging is completed, the speaker 21 of this embodiment is held using packaging components, while, as shown in FIG. 5, the speaker bracket 25 has been fitted to the front end circumferential wall 11b, from the front of the speaker frame 11.

In the state shown in FIG. 6, the speaker 21, to be accommodated with packaging in a box (not shown), is held using packaging components 35 and 36 made, for example, of Styrofoam.

The packaging component 35 is so designed that a step portion 35b, which the rear end face of the front end circumferential wall 11b contacts, is formed around a recessed portion 35a in which the rear portion of the speaker unit 1 is to be accommodated. In this embodiment, a depth d of the step portion 35b is slightly larger than a value obtained by adding a thickness d1 for the front end circumferential wall 11b to a thickness d2 for the speaker bracket 25 that overlaps the front end circumferential wall 11b. As the depth d of the step portion 35b is nearer (d1+d2), the speaker 21 can be held more accurately.

The packaging component 36 is a member used to cover the packaging component 35. When the front end circumferential wall 11b and the speaker bracket 25 are sandwiched between the packaging component 36 and the step portion 35b of the packaging component 35, the speaker unit 1 is prevented from popping out of the recessed portions 35a due to shaking or to a shock received during delivery.

According to the speaker 21 of the first embodiment, during the packaging process, the speaker bracket 25 connected to the speaker unit 1 is attached to the front end circumferential wall 11b of the speaker frame 11, from the front of the speaker unit 1. Thus, the speaker bracket 25 serves as a protective cover that establishes the protective gap S in front of the diaphragm 13 of the speaker unit 1, and covers the front face of the speaker.

Sequentially, when the speaker 21 is packed in a state wherein the speaker bracket 25 has been attached to the front end circumferential wall 11b of the speaker frame 11 from the front of the speaker unit 1, as shown in FIG. 6, a projected portion 36a of the packaging component 36, which prevents the speaker unit 1 from popping out to the front, holds the face of the speaker bracket 25 on which the cabinet aligning portions 32 are formed, without directly contacting the front end circumferential wall 11b of the speaker frame 11. Therefore, when a length L of the projected portion 36a is increased toward the center axis of the speaker 21, the projected portion 36a does not adversely affect the roll edge 15 that is projected outward, from inside the front end circumferential wall 11b, to the front of the speaker 21, and a large contact area is still available for holding the speaker 21.

Therefore, if the box used for the packaging is dropped, the shear force exerted by the speaker unit 1 on the projected portion 36a of the packaging component 36 can be received by and distributed across a large contact area, and the destruction or deformation of the projected portion 36a can be prevented. Therefore, the speaker unit 1 can be immobilized, and can be protected from damage.

Since the speaker bracket 25, which originally is located between the speaker unit 1 and the speaker mounting portion 23 in order to adjust the mounting size, is assembled, from the front, with the front end circumferential wall 11b of the speaker frame 11, the speaker bracket 25 serves as a protective cover that protects the front face of the speaker unit 1, and protection for the speaker unit 1 is reinforced. Thus, an additional packaging component is not especially required to provide reinforced protection.

Therefore, the packaging structure is prevented from becoming complicated due to an increase in the packaging components, a box for packaging can be easily designed because the packaging structure is simplified, and manufacturing costs can be reduced.

### The Second Preferred Embodiment

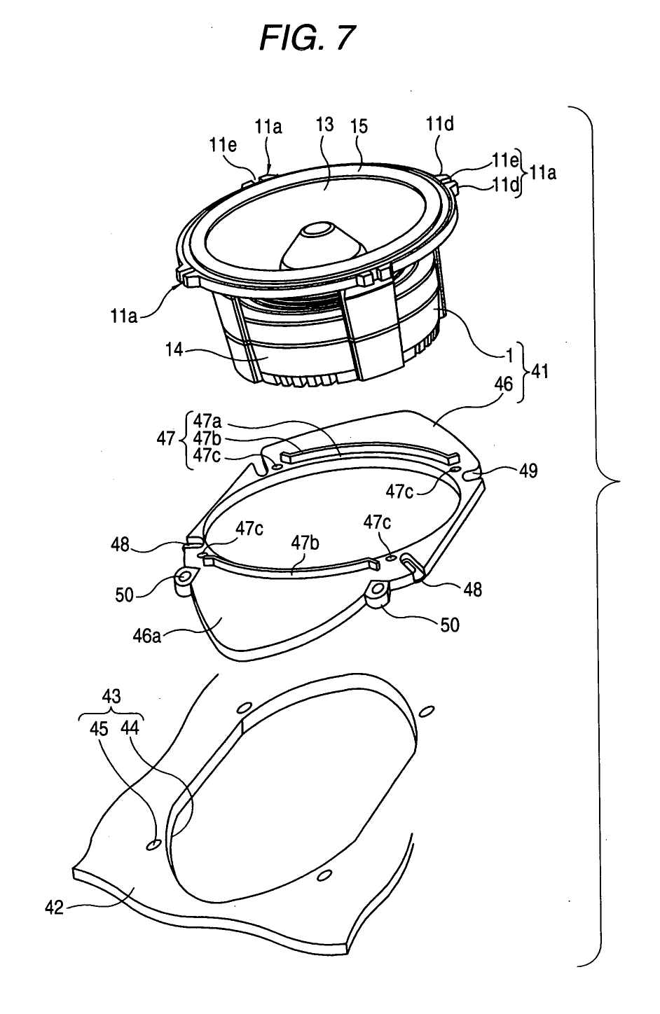

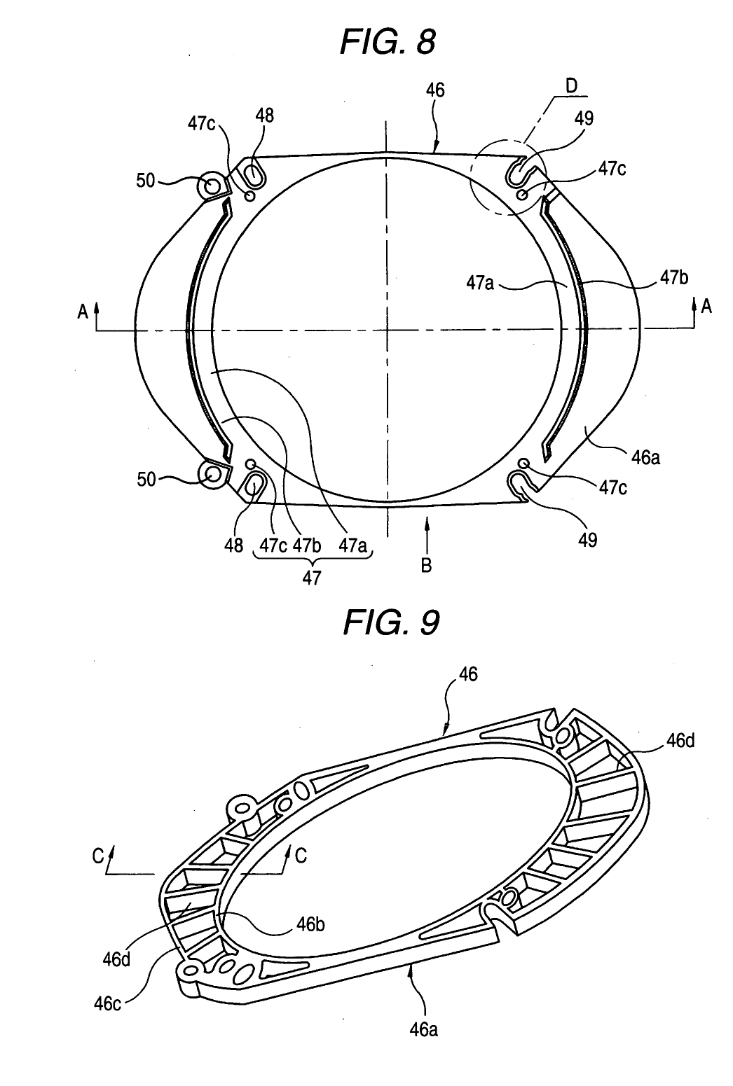

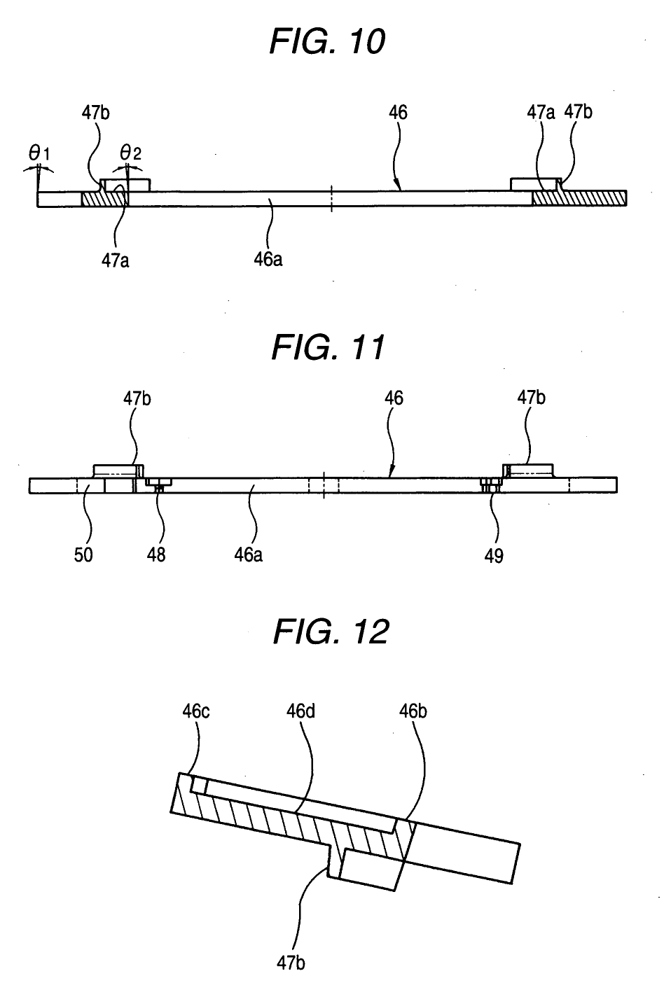

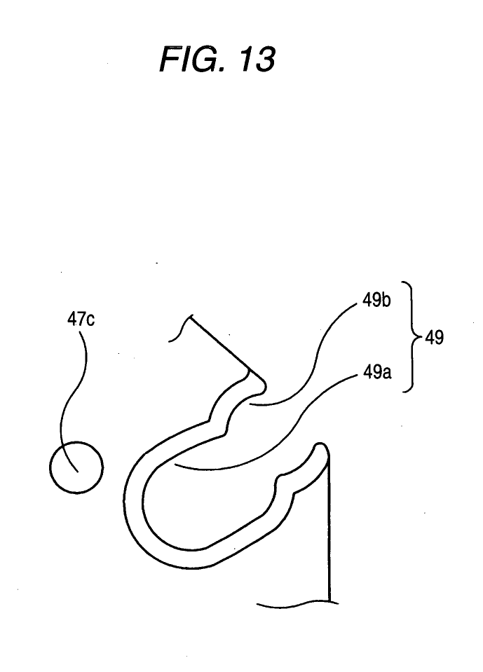

FIGS. 7 to 13 are diagrams showing a speaker bracket and speaker according to a second embodiment of the present invention. FIG. 7 is an exploded perspective view of a case wherein the speaker of the second embodiment is to be attached to a speaker mounting portion. FIG. 8 is a front view of the speaker bracket shown in FIG. 7. FIG. 9 is a rear view of the speaker bracket shown in FIG. 7. FIG. 10 is a cross-sectional view taken along A-A in FIG. 8. FIG. 11 is a diagram of the speaker bracket in FIG. 8, viewed from a direction indicated by an arrow B. FIG. 12 is a cross-sectional view taken along C-C in FIG. 9. And FIG. 13 is an enlarged diagram showing a portion D in FIG. 8.

According to a speaker 41 for the second embodiment, a speaker mounting portion 43, formed of a baffle board 42, includes: an elliptical speaker fitting hole 44 and a plurality of fastening holes 45, formed around the speaker fitting hole 44. Therefore, a speaker bracket 46, the inner circumference of which is substantially formed perfectly circular and the outer circumference of which is elliptical, is connected to a speaker unit 1, the outer circumference of which is substantially a perfect circle, and the speaker unit 1 can be attached to the speaker mounting portion 43.

Since the structure of the speaker unit 1 is the same as that for the first embodiment, no further explanation for it will be given.

The smaller diameter of the elliptical speaker fastening hole 44 is almost equal to, or greater than the outer diameter of a front end circumferential wall 11b.

For the speaker bracket 46 of this embodiment, frame aligning portions 47, which are to be fastened to the front end circumferential wall 11b of a speaker frame 11, are formed on one face of a bracket main body 46a, the inner circumference of which is almost perfectly circular and the outer circumference of which is elliptical. On the other face of the bracket main body 46a, cabinet aligning portions 48, 49 and 50 are formed that are to be fixed to the speaker mounting portion 43 that secures the front end circumferential wall 11b. When the speaker unit 1 is to be attached to the speaker mounting portion 43, these cabinet aligning portions 48, 49 and 50 are used to adjust the mounting size between the front end circumferential wall 11b and the speaker mounting portion 43.

As shown in FIGS. 7 and 8, the obverse side of the bracket main body 46a is simply a flat face. On the other hand, as shown in FIG. 9, on the rear face of the bracket main body 46a, ribs 46d are radially formed to connect an inner vertical wall 46b, which serves as an inner perfectly circular portion, to an outer vertical wall 46c, which serves as an outer elliptical portion, in order to provide additional strength while reducing the weight.

The outer diameter of the bracket main body 46a is so set that it is larger than the diameter of the speaker fitting hole 44, to ensure that the outer circumferential portion overlaps the edge of the speaker fitting hole 44.

As shown in FIG. 8, the frame aligning portions 47 respectively include: a ring-shaped horizontal contact face 47a, which is used in common and which the front face or the rear face of the front end circumferential wall 11b contacts; vertical contact walls 47b, which contact the outer face of the front end circumferential wall 11b and regulate movement along the horizontal contact face 47a; and fastening holes 47c, which are formed in the horizontal contact face 47a in consonance with screw insertion portions 11e of cabinet mounting portions 11a.

The fastening holes 47c are located in consonance with those of the screw insertion portions 11e of the cabinet mounting portions 11a.

The cabinet aligning portions 48 and 49 are respectively screw holes and notches, which are bored through from one face to the other of the bracket main body 46a, in consonance with the fastening holes 45 of the speaker mounting portion 43.

The cabinet aligning portions 48 are simple elliptical holes in cross section. On the other hand, as shown in FIG. 13, the cabinet aligning portions 49 are notches, having a deformed structure in cross section, such that a circular hole 49b is connected to an elliptical hole 49a at the eccentric position of the elliptical hole 49a. This is based on the consideration that only screws at the cabinet aligning portions 48 need be removed, and screws at the cabinet aligning portions 49 may simply be loosened, so that the speaker bracket 46 can be easily removed from the speaker mounting portion 43.

The cabinet aligning portions 50 are spare screw holes used when the arrangement of the fastening holes 45 of the speaker mounting portion 43 is changed again.

Also for the speaker bracket 46 in the second embodiment, the frame aligning portions 47 can be attached to the front end circumferential wall 11b, from the front and from the rear of the speaker frame 11.

In this embodiment, as in the first embodiment, when packing is completed, the speaker 41 is held by using packing components in a state wherein the speaker bracket 46 has been attached to the front end circumferential wall 11b, from the front of the speaker frame 11.

As a result, the same operating effects as in the first embodiment can be obtained.

As described above in detail, according to this embodiment of the invention, provided is the speaker bracket 25, which is formed almost like a ring, on one face of which are provided the frame aligning portions 30 to be fastened to the front end circumferential wall 11b of the speaker frame 11, and on the other face of which are provided the cabinet aligning portions 32 to be fixed to the speaker mounting portion 23 of the cabinet that secures the front end circumferential wall 11b, and which is employed to match the mounting size between the front end circumferential wall 11b and the speaker mounting portion 23 when the speaker unit 1 is attached to the speaker mounting portion 23, wherein the frame aligning portions 30 are formed so as to be attachable from the front end circumferential wall 11b, from the front and from the rear of the speaker frame 11.

According to the above arrangement, during the packaging process, the speaker bracket 25 is attached, from the front of the speaker unit 1, to the front end circumferential wall 11b of the speaker frame 11 and to the speaker unit 1. As a result, the speaker bracket 25 serves as a protective cover that encloses the front face of the speaker, while providing the protective gap S in front of the diaphragm 13 of the speaker unit 1.

As described above in detail, the speaker 21 according to this embodiment includes: the speaker unit 1, formed by assembling the diaphragm 13 and the magnetic circuit 14, for driving the diaphragm 13, with the speaker frame 11 in which the cabinet mounting portions 11a are formed on the front end circumferential wall 11b and are to be fixed to the speaker mounting portion 23 of a cabinet; and the speaker bracket 25, positioned between the front end circumferential wall 11b and the speaker mounting portion 23 for attachment of the speaker unit 1 to the speaker mounting portion 23, and used for matching a mounting size between the front end circumferential wall 11b and the speaker mounting portion 23, wherein the speaker bracket 25 of this embodiment is employed as the speaker bracket 25.

Therefore, when the speaker 21 is packed in a state wherein the speaker bracket 25 has been attached, from the front of the speaker unit 1, to the front end circumferential wall 11b of the speaker frame 11, the projected portion 36a of the packaging component 36, which prevents the speaker unit 1 from popping out to the front, does not directly contact the front end circumferential wall 11b of the speaker frame 11, and holds the other face of the speaker bracket 25 that includes the cabinet aligning portions 32. Therefore, when the length of the projected portion 36a is increased toward the center axis of the speaker 21, the projected portion 36a does not adversely affect the roll edge 15 that projects outward, from inside the front end circumferential wall 11b, to a position forward of the speaker 21. Thus, a large contact area is provided for the projected portion 36a that holds the speaker bracket 25.

Therefore, if a box in which the speaker unit 1 is packaged is dropped, the shear force imposed on the projected portion 36a of the packaging component 36 by the speaker unit 1 is received by and distributed across a large contact area, and the destruction or deformation of the projected portion 36a can be prevented. Thus, the speaker unit 1 can be immobilized and protected from damage.

In this invention, the speaker bracket 25, which originally is located between the speaker unit 1 and the speaker mounting portion 23 to adjust a mounting size, is attached to the front end circumferential wall 11b from the front of the speaker frame 11. Thus, the speaker bracket 25 functions as a protective cover for the front cover of the speaker unit 1, and since it also provides reinforced protection for the speaker unit 1, eliminates the need for an additional packaging component that would furnish such reinforcement.

Therefore, the packaging structure is simplified and prevented from becoming complicated, due to an increase in the packaging components, so that a box for packaging can be easily designed and manufacturing costs can be reduced.

What is claimed is:

1. A speaker bracket, to be disposed between a front end circumferential wall of a speaker frame and a speaker mounting portion of a cabinet as an adjuster, the speaker bracket comprising:
a body formed into an approximate ring shape;
wherein the body includes a first surface and a second surface, the first surface having a frame adjusting portion to be secured to the front end circumferential wall, the second surface having a cabinet adjusting portion to be fixed to the speaker mounting portion; and
the frame adjusting portion is attachable to the front end circumferential wall from both a front side and a rear side of the speaker frame.

2. A speaker to be mounted on a speaker mounting portion of a cabinet, comprising:
a speaker unit including:
a speaker frame including a front end circumferential wall having a cabinet mounting portion, that is formed on the front end circumferential wall,
a diaphragm mounted on the speaker frame, and
a magnetic circuit that drives the diaphragm, and that is mounted on the speaker frame;
a speaker bracket to be disposed between the front end circumferential wall and the speaker mounting portion as an adjuster, the speaker bracket including:
a body formed into an approximate ring shape;
wherein the body includes a first surface and a second surface, the first surface having a frame adjusting portion to be secured to the front end circumferential wall, the second surface having a cabinet adjusting portion to be fixed to the speaker mounting portion; and
the frame adjusting portion is attachable to the front end circumferential wall from both a front side and a rear side of the speaker frame.
